(19) United States
(12) Patent Application Publication
(10) Pub. No.: US 2002/0169989 A1
(43) Pub. Date: Nov. 14, 2002

(54) Method and apparatus for access security in computers

(76) Inventor: Ya-Huang Chen, Taipei Hsien (TW)

Correspondence Address: KEITH KLINE, PRO-TECHTOR INTERNATIONAL SERVICES, 20775 NORADA COURT, SARATOGA, CA, 95070-3018, US

(21) Appl. No.: 09/858,011

(22) Filed: May 14, 2001

(51) Int. Cl. H04L 9/32

(52) U.S. Cl. 713/202

(57) ABSTRACT

The present invention provides a method and apparatus for access security in a computer unit in which a user's identification is processed and ascertained by a control IC card prior to the activation of the computer unit as compared to performing a user validation after the computer unit has been activated. In particular, if the identification data were to be altered or removed prior to the normal shut down procedure within the computer unit, then the control IC card would initiate a suspend function to the computer unit to disengage all input and output (I/O) operations. If the proper personal identification data cannot be revalidated, then the computer unit would remain deactivated, thus totally preventing any unauthorized access by one or more computer hackers.

### BACKGROUND OF THE INVENTION

1. Field of the Invention

The present invention generally relates to a method and apparatus for preventing a computer unit from being illegally accessed. More specifically, a control chip, which only accepts a valid password inputted through a computer keyboard, is used to control the activation of the computer unit as to ensure access security.

2. Description of Related Art

Although the convenience of computers has been greatly accepted and welcomed following the application of individual privacy and financial system, its security can also be a source of concern, especially in view of the fact that the personal payment and identification system on the internet will lead the way in constructing the e-commerce infrastructure. Therefore, before computers can be widely disseminated, one must analysis its current security factors. Otherwise, as long as computers can be illegally accessed, all data contained therein may be stolen or altered.

The traditional method for identifying and protecting a computer unit involves using an OS for identification after the computer unit has been activated, or using a BIOS for identification while the computer unit is activated. However, the traditional method cannot totally prevent unauthorized access from a computer hacker. By contrast, the present invention permits the activation of computer unit only after proper personal identification, instead of performing personal identification after the computer unit has been activated.

### SUMMARY OF THE INVENTION

An object of the present invention is to provide a method and apparatus for access security in the computer unit by validating personal identification data prior to any computer activation, as compare to validating personal identification data after the computer unit has been activated.

Another object of the present invention is to initiate a suspend function in the computer unit as to stop all input and output operations if the personal identification data cannot be located prior to the performing normal deactivation procedure in the computer unit.

The present invention achieves the above-stated objects by providing a method and apparatus for access security in a computer unit which utilizes a personal identification device (e.g., a card reader) to validate personal identification data (e.g., an IC card, fingerprint or voice), then through an I/O control chip (e.g., Winbond Super I/O chip) to activate the computer unit, and thereafter initiating the following steps:

(a) the personal identification device entering a standby status;

(b) inputting personal identification data into the personal identification device;

(c) determining the validity of the personal identification data and returning to step (a) if the personal identification data is invalid;

(d) the personal identification device activating a control circuit, which allows the I/O control chip to activate a computer keyboard and displaying a notification message prompting an authorized user to enter a password;

(e) the authorized user entering the password;

(f) the I/O control chip determining the validity of the password and returning to step (e) if the password is invalid;

(g) the I/O control chip activating the computer unit;

(h) the computer unit returns to normal operations;

(i) searching for the personal identification data in the personal identification device, and jumping to step (n) if the personal identification data are found;

(j) the personal identification device activating a suspend function in the computer unit to stop all I/O operations, and informing the suspend function to the authorized user through a personal identification data display;

(k) searching for new personal identification data and returning to step (1) if not found;

(l) determining the validity of the new personal identification data and returning to step (h) if invalid;

(m) the personal identification device deactivating the suspend function and returning to step (h); and

(n) returning to normal operations for the computer unit.

To supplement the method as discussed above, the present invention also provides the apparatus that includes:

the personal identification data for use by the personal identification device for identifying an authorized user; and

the personal identification device having an I/O control circuit connected to the computer unit as to allow normal operations once the authorized user is identified, suspending all operations of the computer unit when the personal identification data are removed prior to the computer unit being properly shut down, and preventing the computer unit from reactivation if the personal identification data are not revalidated, wherein the computer unit comprises:

a processor;

a North Bridge chip connected to the processor for controlling data flow between the processor and a PCI and allowing the processor to retrieve or save files from devices such as memory and AGP;

a South Bridge chip connected to the North Bridge chip and an I/O control chip and serving as a bridge between a USB interface and I/O control device;

the I/O control chip connected to the South Bridge chip for activating the computer unit after receiving a valid password inputted through a keyboard; and

the keyboard connected to the personal identification device and the I/O control chip which activates the keyboard for inputting the valid password after the authorized user has been identified.

### BRIEF DESCRIPTION OF THE DRAWINGS

FIG. 1 is a schematic diagram showing various elements according to the present invention; and

FIG. 2 is a flow chart showing various steps according the present invention.

### NUMERAL DESIGNATIONS FOR MAIN COMPONENTS

100 Computer unit;

110 Processor;

120 North Bridge Chip;

130 South Bridge Chip;

140 Winbond Super I/O Chip;

150 Computer Keyboard;

160 Serial Port;

170 Parallel Port;

200 Card Reader; and

210 LED.

### DETAILED DESCRIPTION OF THE INVENTION

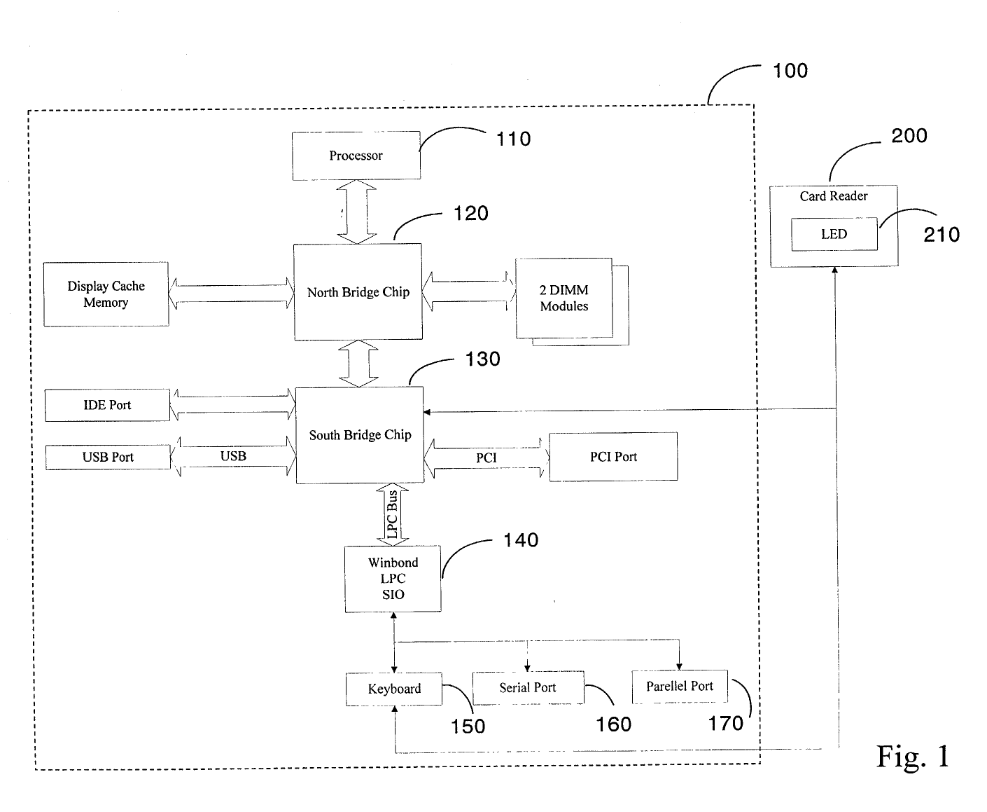

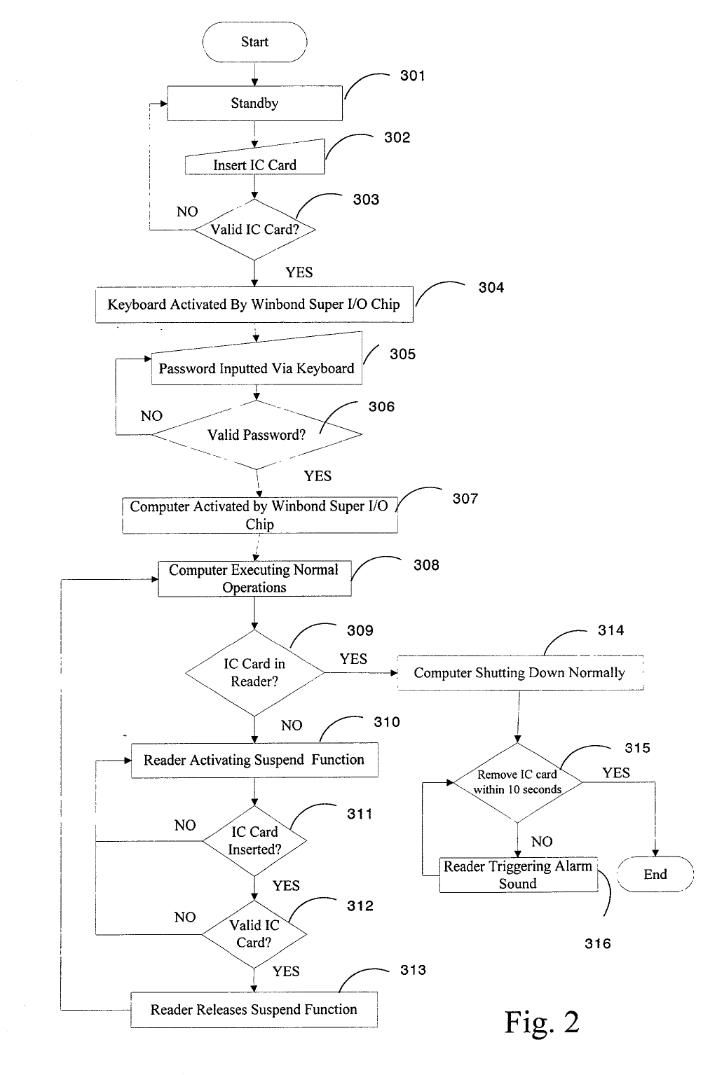

The present invention can be more clearly understood by referring to FIGS. 1 and 2. FIG. 1 shows one embodiment of the present invention in which an IC card is used to carry personal identification data, and the apparatus includes at least the elements discussed hereinbelow.

The IC card (not shown) provides the personal identification data to a card reader 200 to validate an authorized user. The card reader 200, which includes an LED 210, uses a control line to communicate with a computer unit 100 and performs validation function to the IC card. If the authorized user is validated, then the control line is activated to allow the computer unit to perform normal operations. However, if the IC card were to be removed prior to the proper shut down operation of the computer, then the card reader would initiate the suspend function to stop all input and output operations. Moreover, if the revalidation process fails, then the computer unit would remain inactive.

The computer unit 100 includes a processor 110, a North Bridge Chip 120 connected to the processor 110 for controlling data flow between the processor 110 and PCI as to allow the processor to save or retrieve files from devices such as a memory and AGP. By connecting a South Bridge Chip 130 to the North Bridge Chip 120 and a Winbond Super I/O chip 140 (i.e., produced by the Winbond Electronics Corporation), a USB interface and peripheral devices (e.g., a keyboard 150, serial port 160 and parallel port 170) can be bridged with the processor 110.

The Winbond Super I/O chip 140, which is connected to the South Bridge 130, activates the computer unit 100 after accepting a valid password received through the keyboard 150. The card reader 200, which is connected to the keyboard 150 and Winbond Super I/O chip 140, allows the authorized user to input a proper password only after the validation process with respect to the personal identification data has been completed.

FIG. 2 is a flow chart showing various steps of the computer unit security system according to the present invention. After an AC power supply is provided, the card reader 200 enters into a standby status (see step 301). A computer user plugs an IC card into the card reader 200 and retrieve information stored in the IC card (see step 302). Meanwhile, the card reader 200 compares existing data stored in the card reader with the data retrieved from the IC card to determine the validity of the retrieved data (see step 303). If the retrieved data are not valid, then step 301 is repeated. Otherwise, the card reader 200 activates the control line as to allow the activation of the keyboard through the Winbond Super I/O chip, and concurrently allowing the LED 210 in the card reader 200 to display a message prompting the computer user to enter a password (see step 304). After the computer user has entered the password, the Winbond Super I/O 140 determines whether the password is valid. If the password is invalid, then step 305 is repeated. Otherwise, the Winbond Super I/O chip 140 activates the computer unit 100 (see step 307) to perform normal operations (see step 308). At this time, the card reader 200 determines whether the IC card is still within the card reader 200 (see step 309). If the determination is positive, then the computer unit 100 can be shut down according to the normal procedure (see step 314). Therefore, the card reader 200 detects whether the IC card is removed within 10 seconds (see step 315). If the detection is positive, then the procedure is concluded and the card reader 200 reenters into the standby status. Otherwise, the card reader 200 triggers an alarm sound and step 315 is repeated (see step 316).

In step 309, if card reader 200 determines that the IC card is not in the card reader, then the card reader sends a “no IC card” signal to the computer unit and enters into a protection mode, which activates a system suspend function to stop all input and output operations in the computer unit 100 and concurrently enables the LED in the card reader 200 to display a message to the computer user (see step 310). Thereafter, the card reader 200 checks whether the IC card is reinserted. If no reinsertion is detected, then step 310 is repeated. Otherwise, the card reader again determines if the personal identification data in the IC card is valid. If it is invalid, then step 310 is repeated. Otherwise, the suspend status is lifted and step 308 is repeated.

As discussed above, the present invention provides a method and apparatus for ensuring access security to computer units, which can only be activated after proper validation process and not the other way around. Moreover, if the personal identification data is removed prior to the normal deactivation procedure in the computer unit, then the suspend function will be applied to the computer unit to stop all input and output operations. The computer unit also cannot be reactivated if the revalidation process fails. As such, any authorized access by the computer hackers can be prevented.

The foregoing embodiments are to be considered in all aspects illustrative rather than limiting of the invention described herein. The invention may be embodied in other specific forms without departing from the spirit or essential characteristics thereof.

What is claimed is:

1. A method for preventing unauthorized access into a computer unit using a personal identification device and an input and output (I/O) control chip to control the activation of the computer unit, the steps comprising of:
(a) said personal identification device entering into a standby status;
(b) inputting personal identification data into said personal identification device;
(c) determining the validity of said personal identification data and returning to said step (a) if said personal identification data is invalid;
(d) said personal identification device activating a control circuit, which allows said I/O control chip to activate a computer keyboard and displaying a notification message prompting an authorized user to enter a password;
(e) said authorized user entering said password;
(f) said I/O control chip determining validity of said password and returning to said step (e) if said password is invalid;
(g) said I/O control chip activating said computer unit;
(h) said computer unit returns to normal operations;
(i) searching for said personal identification data in said personal identification device, and jumping to step (n) if said personal identification data are found;
(j) said personal identification device activating a suspend function in said computer unit to stop all I/O operations, and informing said suspension to said authorized user through a personal identification data display;
(k) searching for new personal identification data and returning to step j) if not found;
(l) determining the validity of said new personal identification data and returning to said step (h) if invalid;
(m) said personal identification device deactivating said suspend function and returning to step (h); and
(n) returning to normal operations for said computer unit.

2. The method of claim 1, further includes the steps of:
(o) searching for said personal identification data in a preset time period and jumping to step (q) if not found;
(p) triggering an alarm through said personal identification device and returning to step (o); and
(q) said identification device returning to a standby status.

3. The method of claim 1, wherein said personal identification device is a card reader.

4. The method of claims 1, wherein said personal identification data are derived from an IC card.

5. The method of claim 1, wherein said personal identification data display is an LED.

6. The method of claim 2, wherein said preset time period is set for 10 seconds.

7. An apparatus for a computer unit security system comprising:
personal identification data for use by a personal identification device for identifying an authorized user; and
said personal identification-device having an I/O control circuit connected to said computer unit as to allow normal operations when said authorized user is identified, suspending all operations of said computer unit when said personal identification data are removed prior to said computer unit being shut down, and preventing said computer unit from reactivation if said personal identification data is not revalidated, wherein said computer unit comprises:
a processor;
a North Bridge chip connected to said processor for controlling data flow between said processor and a PCI and allowing said processor to retrieve or save files from at least a memory and AGP;
a South Bridge chip connected to said North Bridge chip and an I/O control chip and serving as a bridge between a USB interface and said I/O control device;
said I/O control chip connected to said South Bridge chip for activating said computer unit after receiving a valid password inputted through a keyboard; and
said keyboard connected to said personal identification device and said I/O control chip which activates said keyboard for inputting said valid password after said authorized user has been identified.

8. The apparatus of claim 7, wherein said personal identification device includes an LED.

9. The apparatus of claim 7, wherein said personal identification device includes a timer for reminding said authorized user regarding the non-removal of said personal identification data within a preset time period after said computer unit has been deactivated.

10. The apparatus of claim 7, wherein said preset time period is set for 10 seconds.

11. The apparatus of claim 7, wherein said personal identification device is a reader.

12. The apparatus of claim 7, wherein said personal identification data are derived from an IC card.
